(19) United States
(12) Patent Application Publication
(10) Pub. No.: US 2018/0347374 A1
(43) Pub. Date: Dec. 6, 2018

(54) AIRFOIL WITH TIP RAIL COOLING

(71) Applicant: General Electric Company, Schenectady, NY (US)

(72) Inventors: Matthew Thomas Beyer, Hartland, WI (US); Gregory Terrence Garay, West Chester, OH (US); Aaron Ezekiel Smith, Montgomery, OH (US)

(21) Appl. No.: 15/609,430

(22) Filed: May 31, 2017

(51) Int. Cl. F01D 5/18

(52) U.S. Cl. CPC F01D 5/187; F05D 2260/20; F05D 2240/301; F05D 2220/323

(57) ABSTRACT

An apparatus and method for cooling an airfoil tip for a turbine engine can include an airfoil, such as a cooled turbine blade, having a tip rail extending beyond a tip wall enclosing an interior for the airfoil at the tip. A plurality of cooling holes can be provided in the tip rail. A flow of cooling fluid can be provided through the cooling holes from the interior of the airfoil to cool the tip of the airfoil.

### BACKGROUND OF THE INVENTION

Turbine engines, and particularly gas or combustion turbine engines, are rotary engines that extract energy from a flow of combusted gases passing through the engine onto a multitude of rotating turbine blades, and in some cases, such as aircraft, generate thrust for propulsion.

Gas turbine engines for aircraft are designed to operate at high temperatures to maximize engine efficiency, so cooling of certain engine components, such as a high pressure turbine and a low pressure turbine, can be beneficial. Typically, cooling is accomplished by ducting cooler air from high and/or low pressure compressors to the engine components that require cooling. Temperatures in the high pressure turbine can be 1000° C. to 2000° C. and the cooling air from the compressor can be 500° C. to 700° C., enough of a difference to cool the high pressure turbine.

Contemporary turbine blades, as well as vanes or nozzles, generally include one or more interior cooling circuits for routing the cooling air through the blade to cool different portions of the blade, and can include dedicated cooling circuits for cooling different portions of the blade, such as the leading edge, trailing edge and tip of the blade.

### BRIEF DESCRIPTION OF THE INVENTION

In one aspect, the disclosure relates to an airfoil comprising an outer wall bounding an interior and defining a pressure side and a suction side extending between a leading edge and a trailing edge to define a chord-wise direction and extending between a root and a tip to define a span-wise direction, a tip rail projecting from the tip in the span-wise direction and defining a tip plenum, and at least one cast cooling channel extending from an inlet communicating with the interior to an outlet at the tip near the trailing edge of the airfoil where the tip rail defines at least a portion of the outlet.

In another aspect, the disclosure relates to an airfoil comprising an outer wall bounding an interior and defining a pressure side and a suction side extending between a leading edge and a trailing edge to define a chord-wise direction and extending between a root and a tip to define a span-wise direction, a tip rail projecting from the tip in the span-wise direction and defining a tip plenum, and multiple cooling channels extending from inlets communicating with the interior to outlets at the tip near the trailing edge of the airfoil where the tip rail defines at least a portion of the outlets and the outlets are fluidly isolated from each other.

In yet another aspect, the disclosure relates to a method of cooling a tip of an airfoil, the method comprising supplying a cooling fluid through a cooling channel from an interior of the airfoil, emitting the cooling fluid through an outlet within a tip plenum defined by a tip rail of the airfoil, and impinging the cooling fluid onto an interior surface of the tip rail.

### BRIEF DESCRIPTION OF THE DRAWINGS

In the drawings:

FIG. 1 is a schematic cross-sectional diagram of a portion of a turbine engine for an aircraft.

FIG. 2 is an isometric view of an airfoil of the engine of FIG. 1 including a tip with cooling holes.

FIG. 3 is section view of the airfoil of FIG. 2 taken across section illustrating cooling passages within the airfoil.

FIG. 4 is an isometric view of the tip with cooling holes at a trailing edge of the airfoil from FIG. 2.

FIG. 5 is a top view of the tip at the trailing edge of the airfoil from FIG. 2.

FIG. 6A is a cross-sectional view of an investment casting core portion for forming some of the cooling holes from FIG. 2.

FIG. 6B is a cross-sectional view of an alternative investment casting core portion for forming some of the cooling holes from FIG. 2.

FIG. 7 is the isometric view of FIG. 4 showing a method of cooling the tip of the airfoil.

### DETAILED DESCRIPTION OF THE INVENTION

Aspects of the disclosure described herein are directed to a tip of an airfoil including cooling holes having outlets formed in at least a portion of a tip rail. For purposes of illustration, the present disclosure will be described with respect to a blade for a turbine in an aircraft gas turbine engine. It will be understood, however, that aspects of the disclosure described herein are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference. A “set” as used herein can include any number of a particular element, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

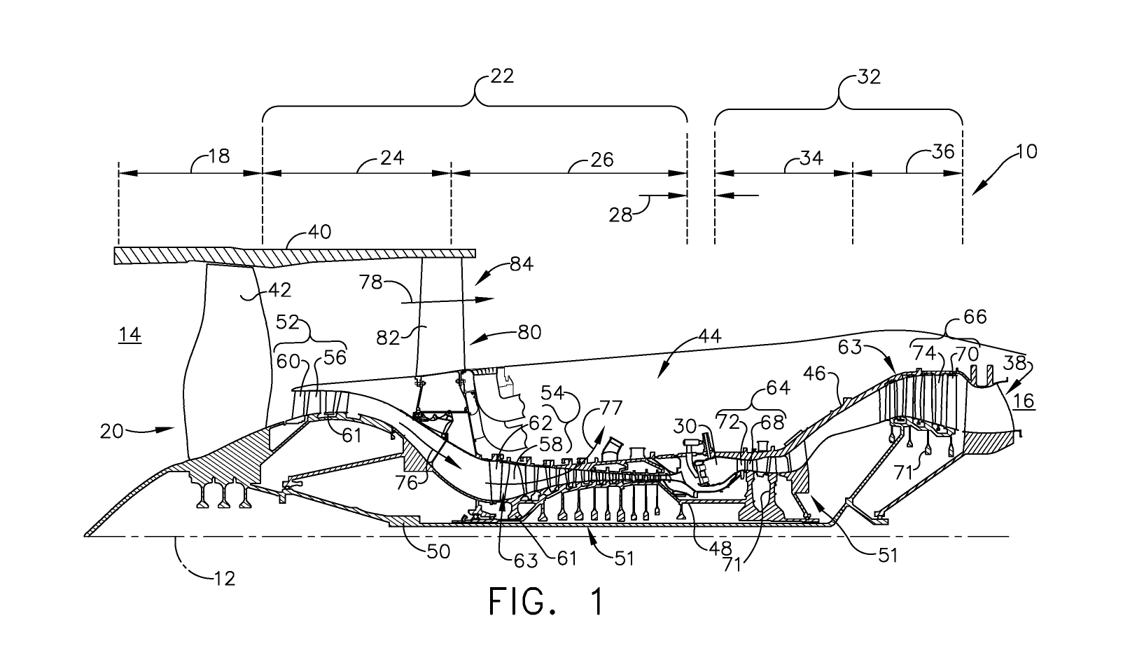

FIG. 1 is a schematic cross-sectional diagram of a portion of a gas turbine engine 10 for an aircraft. The engine 10 has a longitudinally extending axis or centerline 12 extending from forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12 and rotatable within the fan casing 40. The HP compressor 26, the combustor 30, and the HP turbine 34 form a core 44 of the engine 10, which generates and extracts energy from combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and are ultimately discharged from the engine 10 via the exhaust section 38. The driving of the LP turbine 36 drives the LP spool 50 to rotate the fan 20 and the LP compressor 24.

A portion of pressurized airflow 76 generated in the compressor section 22 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of airflow 78 from the fan section 18 bypasses the LP compressor 24 and engine core 44 and exits the engine assembly 10 through a stationary vane row, and more particularly an outlet guide vane assembly 80, comprising a plurality of airfoil guide vanes 82, at a fan exhaust side 84. More specifically, a circumferential row of radially extending airfoil guide vanes 82 is utilized adjacent the fan section 18 to exert some directional control of the airflow 78.

The airflow 78 can be a cooling fluid used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

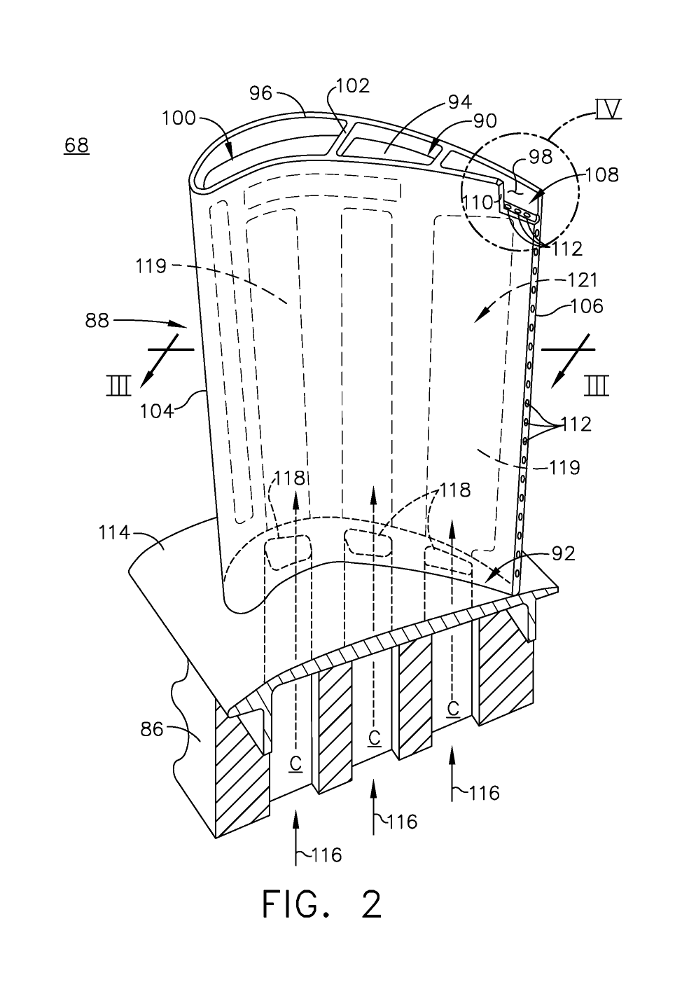

Referring to FIG. 2, an engine component in the form of one of the turbine blades 68 includes a dovetail 86 and an airfoil 88. The airfoil 88 includes a tip 90 and a root 92 defining a span-wise direction therebetween. A tip wall 94 is provided at the tip 90, with a tip rail 96 having an interior surface 98 and extending from the tip wall 94 to define a tip plenum 100. An optional tip baffle 102 is shown at the tip 90 and extends from the tip rail 96 along the tip wall 94. The airfoil further includes a leading edge 104 and a trailing edge 106 defining a chord-wise direction therebetween. The tip rail 96 circumscribes the airfoil 88 except for a gap 108 defining a tip slot 110 of the tip rail 96 as highlighted in circle IV. A plurality of cooling holes 112 are provided at the tip 90 proximate the tip rail 96 within the gap 108. It is also contemplated that cooling holes 112 can be provided in the span-wise direction along the trailing edge 106 of the airfoil 88.

The airfoil 88 mounts to the dovetail 86 by way of a platform 114 at the root 92. The platform 114 helps to radially contain a turbine engine mainstream airflow driven by the blade 68. The dovetail 86 can be configured to mount to a turbine rotor disk on the engine 10 to drive the blade 68. The dovetail 86 further includes at least one inlet passage 116, with the exemplary dovetail 86 shown as a having three inlet passages 116. The inlet passages 116 extend through the dovetail 86 and the platform 114 to provide internal fluid communication with the airfoil 88 at corresponding passage outlets 118. Each of the passage outlets 118 can be fluidly coupled to one or more internal cooling passages 119. The inlet passages 116, passage outlets 118, internal cooling passages 119, and cooling holes 112, can be fluidly coupled to each other and form one or more cooling circuits 121 within the airfoil 88. It should be appreciated that the dovetail 86 is shown in cross-section, such that the inlet passages 116 are enclosed within the body of the dovetail 86. A flow of cooling fluid C, such as airflow 77 and/or airflow 78 can be provided to the airfoil 88 through the inlet passage 116 exhausting at the passage outlets 118.

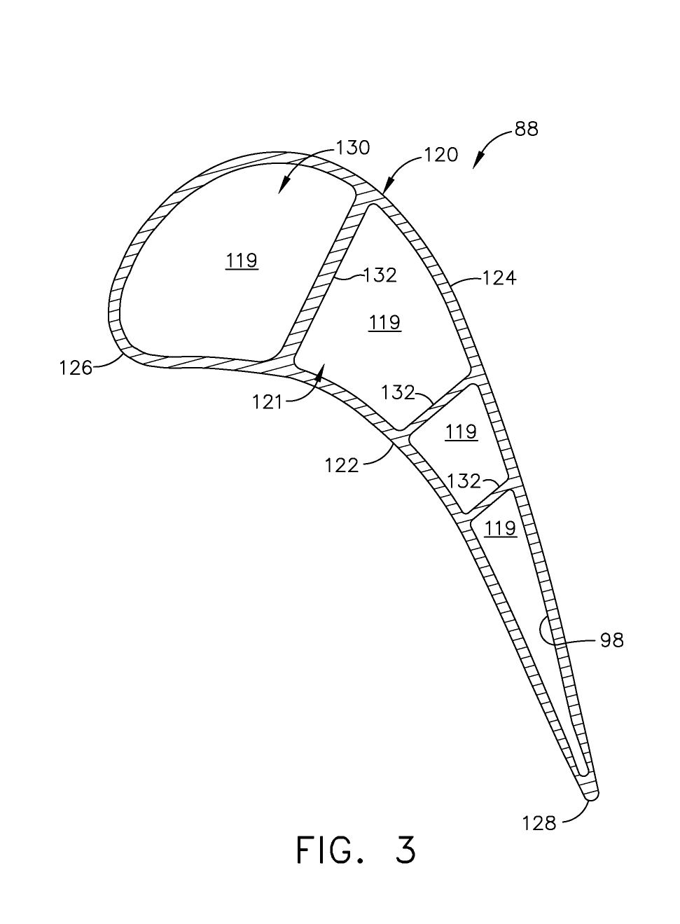

Referring now to FIG. 3, the airfoil 88 includes an outer wall 120 with a concave-shaped pressure side 122 and a convex-shaped suction side 124 joined together to define the shape of airfoil 88. During operation, the airfoil 88 rotates in a direction such that the pressure side 122 follows the suction side 124. Thus, as shown in FIG. 3, the airfoil 88 would rotate upward toward the top of the page.

An interior 130 is defined by the outer wall 120. One or more interior walls shown as ribs 132 can divide the interior 130 into the multiple cooling passages 119. The cooling passages 119 can fluidly couple to one or more other cooling passages 119 or features formed within the airfoil 88 to define one or more of the cooling circuits 121. It should be appreciated that the interior structure of the airfoil 88 is exemplary as illustrated. The interior 130 of the airfoil 88 can be organized in a myriad of different ways, and the cooling passages 119 can include single passages extending in the span-wise direction, or can be complex cooling circuits, having multiple features such as passages, channels, inlets, outlets, ribs, pin banks, circuits, sub-circuits, film holes, plenums, mesh, turbulators, or otherwise in non-limiting examples. Preferably, the cooling passages 119 will be in fluid communication with the inlet passages 116 of the dovetail 86. At least one of the cooling passages 119 is in fluid communication with the cooling holes 112.

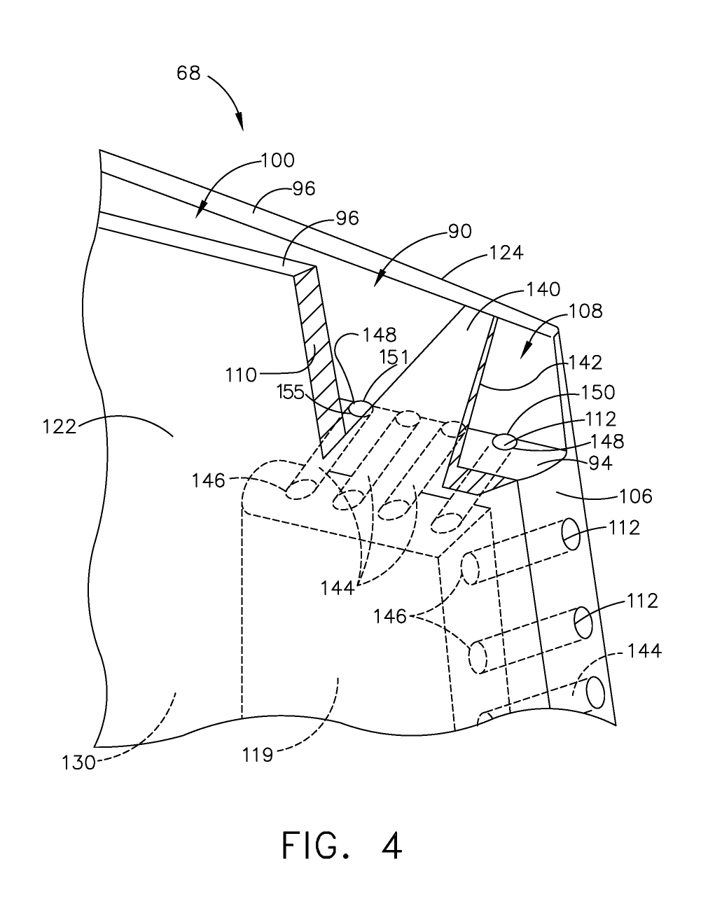

Referring now to FIG. 4, the gap 108 is enlarged to illustrate a support panel 140. The support panel 140 can be a wedge or rib shaped to at least partially enclose the gap 108. The support panel 140 is secured to the tip 90 at the tip wall 94 proximate the trailing edge 106 along the pressure side 122. The support panel 140 extends from the tip wall 94 to the tip rail 96 and is secured to the tip rail 96 along the suction side 124. The support panel 140 therefore partially encloses the tip plenum 100 with an interior surface 142 facing the tip wall 94. The support panel 140 therefore partially fills the gap 108. While illustrated with a support panel 140, it should be understood that the support panel 140 is an optional feature having any shape or form. It is further contemplated that tip rail 96 can fully circumscribe the airfoil 88 completely filling in the tip slot 110 partially enclosing the tip plenum 100 proximate the trailing edge 106.

The tip wall 94 encloses the interior 130 of the airfoil 88. The tip wall 94 can be substantially flat, while contouring of the tip wall 94 is contemplated. The tip wall 94 can extend substantially orthogonal to the adjacent outer wall 120. Additionally, the tip wall 94 can at least partially form one or more of the cooling passages 119, as well as the cooling circuit 121.

A cast cooling channel 144 can fluidly couple the cooling passage 119 to the cooling holes 112. The cast cooling channel 144 extends from an inlet 146 at the cooling passage 119 to an outlet 148 defining the cooling hole 112 at the tip 90. The outlet 148 is located along the outer wall 120 at the suction side 124 of the airfoil 88. It should be understood that the outlet 148 could be located along the pressure side 122 if the airfoil temperatures require greater cooling on the pressure side. The outlet 148 is located at least in part within the tip plenum 100 where the suction side 124 meets the pressure side 122 at the trailing edge 128 of the airfoil. While each cooling hole 112 is shown as having an inlet 146 and an outlet 148, it is contemplated that the cooling holes 112 can share inlets 146 or outlets 148 as is desirable based upon flow rates and requirements of the particular airfoil 88. It is further contemplated that the cast cooling channels 144 also fluidly couple the cooling passage 119 to the trailing edge 106 and cooling holes 112 along the trailing edge 106. Additionally it should be understood that the cast cooling channels 144 could be located anywhere along the chord of the airfoil including the leading edge 126 depending on the areas needing the most cooling.

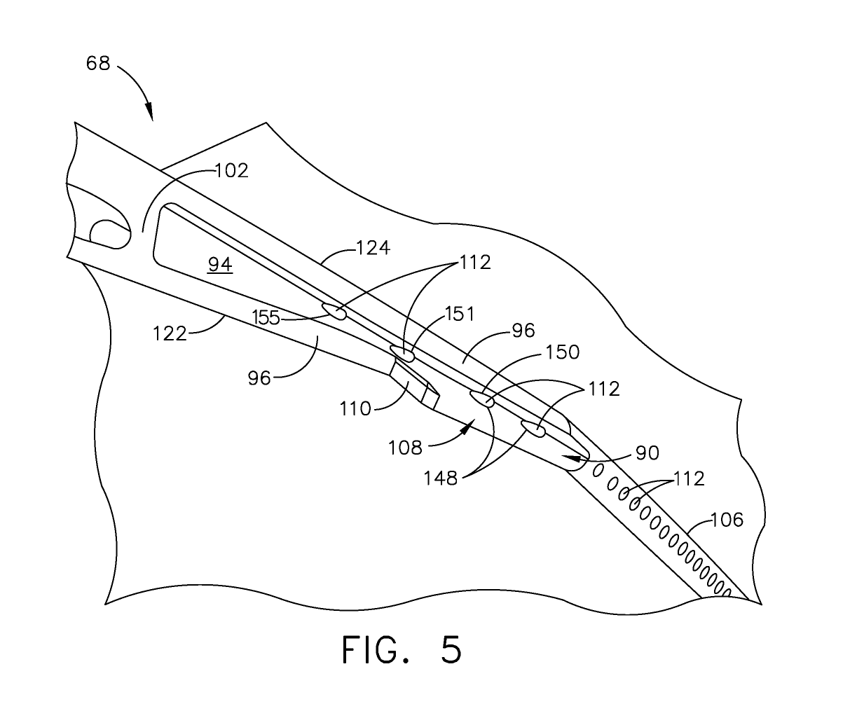

Turning to FIG. 5 a top view of FIG. 4 more clearly depicts the outlet 148 having a perimeter 150 where the tip rail 96 defines at least a portion 151 of the perimeter 150. A remaining portion 155 of the perimeter 150 can be located in the tip wall 94. It is further contemplated that the cast cooling channels 144 terminate in an outlet 148 having an oblong or oval shape to define a diffuser section. The type of channel and shape of the outlet depicted are for illustrative purposes and not meant to be limiting.

The cast cooling channel 144 can be a plurality of cast cooling channels 144 having outlets 148 along the tip rail 96 where at least a portion 151 of the perimeter 150 of each cooling hole 112 is defined by the tip rail 96. The support panel 140 has been removed for clarity and illustrates each outlet 148 fluidly isolated from other outlets 148. To enable cast cooling channels 144 with outlets 148 along the tip rail 96, an investment casting process is used.

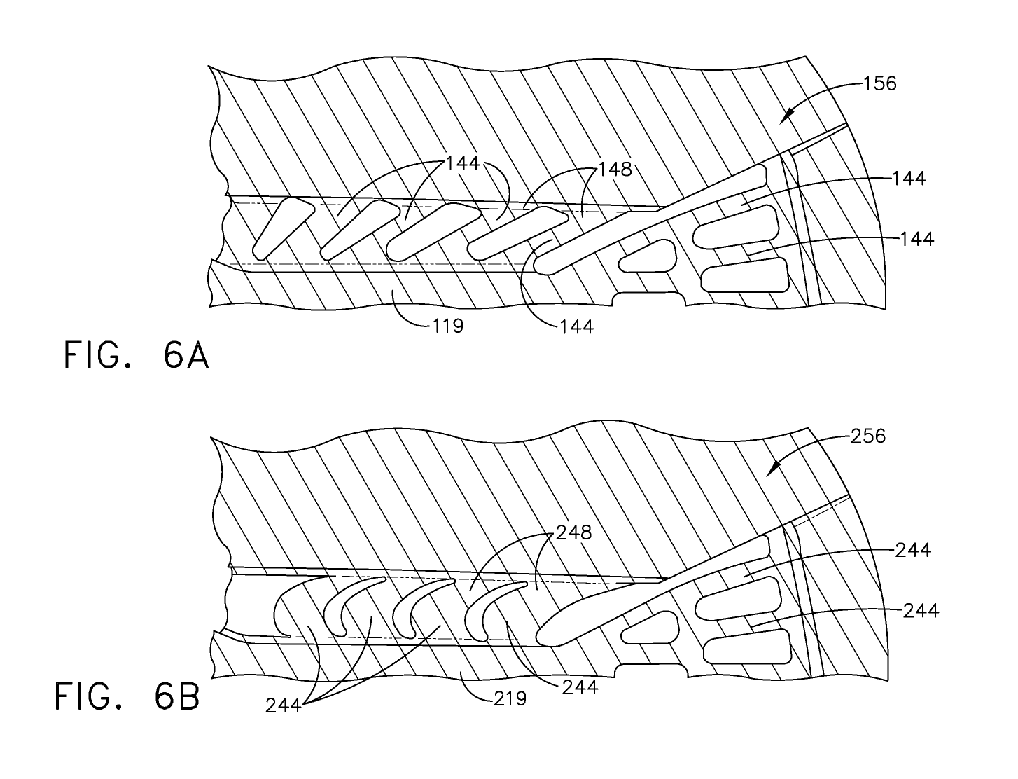

Turning to FIG. 6A a portion of an investment casting core 156 is illustrated in an exemplary layout for the cast cooling channels 144. During the investment casting process one or more molds enclose an investment casting core 156. A molten material, by way of non-limiting example a metal alloy, is introduced into molds and cooled to form the airfoil 88. The investment casting core 156 can be removed by leaching where the investment casting core 156 can be liquefied, in one non-limiting example by heating, and drained out through leach holes (not shown).

The investment casting core 156 forms the cooling passages 119 and cooling channels 144. Thus, the investment casting core is a solid representation of the internal passages, in particular the cooling passages 119 and the cast cooling channels 144, that will be present in the airfoil 88 upon completion.

The cooling holes 112 and cooling channels 144 can be angled, contoured, and non-line-of-sight for heat transfer optimization. Another exemplary layout for a solid representation of cooling channels 244 is illustrated in FIG. 6B. An investment casting core 250 can be molded with curved cooling channels 242 such that cooling air C is introduced to a tip rail 200 at a particular angle. Other geometries of the cast cooling channels 144, 244 are contemplated and should not be limited to the illustrated exemplary layouts.

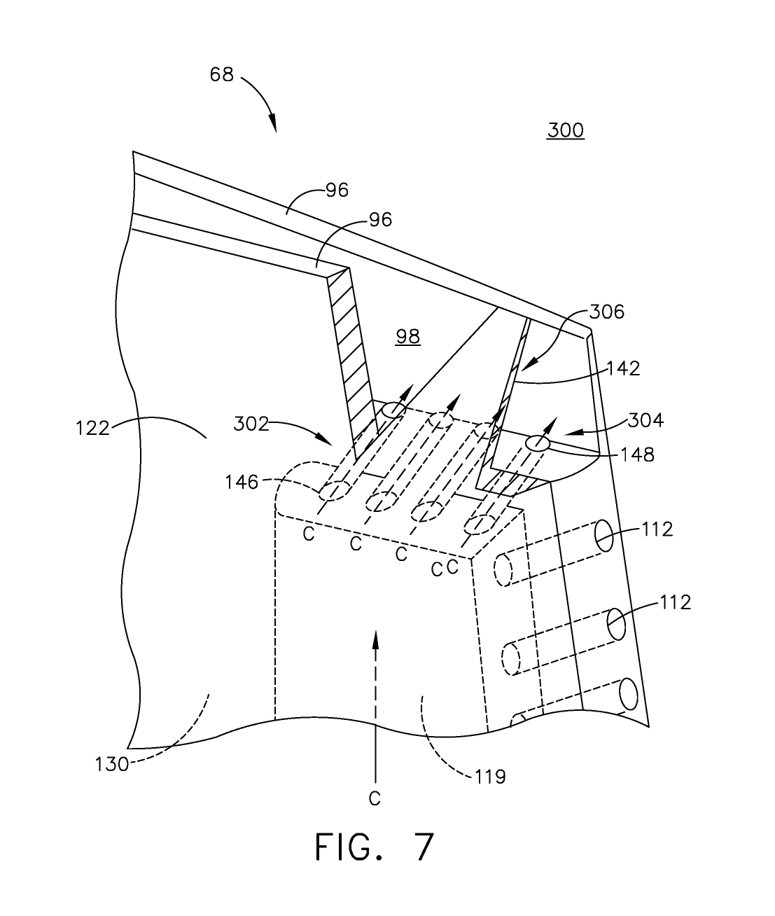

Turning to FIG. 7, a method 300 of cooling the tip 90 of the airfoil 88 is illustrated in a figure similar to FIG. 4. For clarity some numerals from FIG. 4 have been removed. The method 300 includes at 302 supplying a cooling fluid C through the cooling passage 119 from the interior 130 of the airfoil 88. Then at 304 emitting the cooling fluid C through the outlet 148 along the tip rail 96. Finally at 306 impinging the cooling fluid C onto an interior surface 98 of the tip rail 96. The impinging occurs at or proximate the trailing edge 106 of the airfoil. It is further contemplated that the surface on which the impinging occurs is an interior surface 142 of the support panel 140.

Aspects of the disclosure discussed herein are towards cast cooling holes at the tip of an airfoil that promote heat transfer and film cooling delivery to locations not typically accessible for machined cooling holes, by way of non-limiting example drilling cooling holes at the tip of an airfoil near the trailing edge. While the disclosure discussed herein is towards the trailing edge of the tip, it is not necessarily limited to the trailing edge tip corner.

Benefits associated with the cooling holes discussed herein include improved heat transfer at the trailing edge tip where the geometry typically prevents drilling of cooling holes. This allows film placement in areas where traditional machining cannot reliably manufacture, in that the hole can be placed directly on a side wall for improved film performance, where traditional machining requires some clearance from the wall. Tip film performance along the tip rail by having cast cooling holes directly along the wall is also improved. Utilizing an investment casting process allows shaped hole geometry, non-line-of-sight holes, and non-linear holes, improving heat transfer and film performance.

An additional benefit associated with the investment casting core is that the solid representation of the cast cooling channels act as core supports and leaching holes during production of the airfoil. These solid representations of the cast cooling channels replace typical radial core supports with contoured supports that are usable as cooling holes, improving core producibility. Utilizing the solid representations of the cast cooling channels as core supports replaces traditional tip rods which can decrease cost and improve yields.

Adding a support panel on airfoils with a tip slot improves stiffness of the panel which can aid in improving high cycle fatigue capabilities, particular for the tip rail at the trailing edge. Traditional machining cannot reliably drill at locations with tight ribs/tip rails and therefore the cast cooling holes allow for better film performance at the trailing edge tip which in turn equals better specific fuel consumption and/or improved durability of the blade.

To the extent not already described, the different features and structures of the various embodiments can be used in combination with each other as desired. That one feature is not illustrated in all of the embodiments is not meant to be construed that it cannot be, but is done for brevity of description. Thus, the various features of the different embodiments can be mixed and matched as desired to form new embodiments, whether or not the new embodiments are expressly described. All combinations or permutations of features described herein are covered by this disclosure.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An airfoil comprising:
an outer wall bounding an interior and defining a pressure side and a suction side extending between a leading edge and a trailing edge to define a chord-wise direction and extending between a root and a tip to define a span-wise direction;
a tip rail projecting from the tip in the span-wise direction and defining a tip plenum; and
at least one cooling channel extending from an inlet communicating with the interior to an outlet at the tip near the trailing edge of the airfoil where the tip rail defines at least a portion of the outlet.

2. The airfoil of claim 1 wherein the outlet is located along the outer wall at the suction side of the airfoil.

3. The airfoil of claim 2 wherein at least a portion of the outlet is located within the tip plenum.

4. The airfoil of claim 1 wherein the at least one cooling channel is a cast cooling channel.

5. The airfoil of claim 4 wherein the cast cooling channel is a plurality of cast cooling channels with outlets along the tip rail.

6. The airfoil of claim 5 wherein at least one of the cast cooling channels is curved.

7. The airfoil of claim 1 wherein the outlet has a perimeter and the tip rail defines at least a portion of the perimeter.

8. The airfoil of claim 7 wherein the outlet is located in the tip plenum where the suction side meets the pressure side.

9. The airfoil of claim 1 wherein the tip rail circumscribes the airfoil except for a gap at the trailing edge that forms a tip slot.

10. The airfoil of claim 9 further including a rib extending from the tip at the tip slot to the tip rail.

11. An airfoil comprising:
an outer wall bounding an interior and defining a pressure side and a suction side extending between a leading edge and a trailing edge to define a chord-wise direction and extending between a root and a tip to define a span-wise direction;
a tip rail projecting from the tip in the span-wise direction and defining a tip plenum; and
multiple cooling channels extending from inlets communicating with the interior to outlets at the tip near the trailing edge of the airfoil where the tip rail defines at least a portion of the outlets and the outlets are fluidly isolated from each other.

12. The airfoil of claim 11 wherein the outlet is located along the outer wall at the suction side of the airfoil.

13. The airfoil of claim 12 wherein at least a portion of the outlet is located within the tip plenum.

14. The airfoil of claim 13 wherein the outlet is located in the tip plenum where the suction side meets the pressure side.

15. The airfoil of claim 11 wherein the tip rail circumscribes the airfoil except for a gap at the trailing edge that forms a tip slot.

16. The airfoil of claim 15 further including a rib extending from the tip at the tip slot to the tip rail.

17. The airfoil of claim 11 wherein the multiple cooling channels are cast cooling channels.

18. The airfoil of claim 17 wherein at least one of the cast cooling channels is curved.

19. A method of cooling a tip of an airfoil, the method comprising:
supplying a cooling fluid through a cooling channel from an interior of the airfoil;
emitting the cooling fluid through an outlet within a tip plenum defined by a tip rail of the airfoil; and
impinging the cooling fluid onto an interior surface at the tip rail.

20. The method of claim 18 wherein the impinging occurs at a trailing edge of the airfoil onto an interior surface of a support panel.

21. The method of claim 18 wherein the supplying a cooling fluid further includes supplying a cooling fluid through a cast cooling channel.
